(19) United States
(12) Patent Application Publication
(10) Pub. No.: US 2011/0090600 A1
(43) Pub. Date: Apr. 21, 2011

(54) SUSPENSION, HEAD GIMBAL ASSEMBLY AND DISK DRIVE UNIT WITH THE SAME

(75) Inventor: Xianwen Feng, DongGuan (CN)

(73) Assignee: SAE Magnetics (H.K.) Ltd., Hong Kong (CN)

(21) Appl. No.: 12/700,780

(22) Filed: Feb. 5, 2010

(30) Foreign Application Priority Data
Oct. 16, 2009 (CN) 200910174814.6

(51) Int. Cl. G11B 5/48

(52) U.S. Cl. 360/245.3; 360/246.4; G9B/5.147

(57) ABSTRACT

A suspension for a head gimbal assembly comprises a flexure having a suspension tongue and a welding portion separating from the suspension tongue, and a load beam supporting the suspension tongue and having a portion welded to the welding portion of the flexure so that the load beam and the flexure are connected together. A plurality of bonding pads is formed on the suspension tongue for electrical connection to a slider. The suspension tongue has a leading portion and a leading edge limiter formed at the leading portion, and the leading edge limiter hooks on to the load beam. The suspension can improve the shockproof performance of the flexure of the suspension and, in turn, protect the structure of the suspension. The invention also discloses a head gimbal assembly and a disk drive unit including the same.

### FIELD OF THE INVENTION

The present invention relates to information recording disk drive devices and, more particularly, to a suspension, head gimbal assembly (HGA) and disk drive unit including the same.

### BACKGROUND OF THE INVENTION

Hard disk drives are common information storage devices. FIG. 1a provides an illustration of a typical disk drive unit 100 essentially consisting of a series of rotatable disks 101 mounted on a spindle motor 102, and a Head Stack Assembly (HSA) 130 which is rotatable about an actuator arm axis 105 for accessing data tracks on disks during seeking. The HSA 130 includes at least one drive arm 104 and HGA 150. Typically, a spindling voice-coil motor (VCM) is provided for controlling the motion of the drive arm 104.

Referring to FIG. 1b, the HGA 150 includes a slider 103 having a reading/writing transducer (not shown) imbedded therein, a suspension 190 to load or suspend the slider 103 thereon. When the disk drive is on, a spindle motor 102 will rotate the disk 101 at a high speed, and the slider 103 will fly above the disk 101 due to the air pressure drawn by the rotated disk 101. The slider 103 moves across the surface of the disk 101 in the radius direction under the control of the VCM. With a different track, the slider 103 can read data from or write data to the disk 101.

FIG. 1c shows a conventional suspension, the suspension 190 includes a load beam 106, a base plate 108, a hinge 107 and a flexure 105, all of which are assembled together.

The load beam 106 is connected to the base plate 108 by the hinge 107. A locating hole 112 is formed on the load beam 106 for aligning the load beam 106 with the flexure 105. And the load beam 106 is welded with the flexure for increasing the strength of the entire structure.

The base plate 108 is used to enhance structure stiffness of the whole HGA 100. A mounting hole 113 is formed on one end of the base plate 108 for mounting the whole HGA to the motor arm 104 (referring to FIGS. 1a-1b). Another hole 110 is formed on the other end of the base plate 108, which is aligned with a hole 110′ formed on the hinge 107 and a hole 110″ formed on the flexure 105. The hinge 107 has a mounting hole 113′ formed on its one end corresponding to the mounting hole 113 of the base plate 108, and the hinge 107 is partially mounted to the base plate 108 with the mounting holes 113′, 113 aligned with each other. The hinge 107 and the base plate 108 may be mounted together by laser welding at pinpoints 109 distributed on the hinge 107. Two hinge steps 115 are integrally formed at a side of the hinge 107 at one end adjacent the mounting hole 110 for connecting with the flexure 105.

The flexure 105 is made of flexible material and runs from the hinge 107 to the load beam 106. The flexure 105 has a proximal end 119 adjacent the hinge 107 and a distal end 118 adjacent the load beam 106. A locating hole 112′ is formed on the distal end 118 of the flexure 105 and aligned with the locating hole 112 of the load beam 106, thus obtaining a high assembly precision. A suspension tongue 116 is provided at the distal end of the flexure 105 to carry the slider 103 thereon.

FIG. 1d shows a more detailed structure of the flexure 105 shown in FIG. 1c. As illustrated in the figure, a plurality of suspension traces 120 is formed on the flexure 105 along length direction thereof. One end of the traces 120 is electrically connected to a preamplifier (not shown), and the other end thereof extends into the suspension tongue 116. The suspension tongue 116 has a plurality of bonding pads 117 formed thereon for coupling the slider 103. The suspension tongue 116 is supported by a pair of cross bars 122 extending from two lateral sides thereof respectively. The cross bars 122 are further connected to a pair of straight struts 121 respectively, which are formed at distal end of the flexure 105. The flexure 105 further includes a welding portion 124 separated from the suspension tongue 116, a pair of arms 123 respectively connected to the pair of straight struts 121. The welding portion 124 of the flexure 105 is welded to the load beam 106.

As the technology of the information recording disk drive devices develops, several types of slider have been applied in the HGA. On one hand, the Pico slider (length=1.25 mm, width=1.00 mm, height=0.3 mm) is widely used from 1997. And on the other hand, a new-style Femto slider has been exploited in 2003 by Hitachi Company. The size of the Femto slider (length=0.85 mm, width=0.70 mm, height=0.23 mm) is much smaller than the Pico slider, and the weight is much lighter, making the movement above the track easier. Such a design of the HGA described above is cooperated with the Femto slider. However, as the extremely small size of the Femto slider, the difficultly of the manufacturing thereof is increased. Moreover, the strength of the Femto slider is decreased due to the reducing size.

Accordingly, an appropriate slider is researched for maintaining the strength and the relative small dimension, whose size is between the Pico slider and the Femto slier. That is the Pemto slider (length=1.235 mm, width=0.7 mm, height=0.23 mm). When the Pemto slider is applied to the conventional HGA described as above, some problems come out.

When the Pemto slider is mounted on the suspension of the HGA, the suspension tongue 116 of the flexure 105 supports the Pemto slider. The welding portion 124 of the flexure 105 is welded to the load beam 106 and the welding portion 124 is separated from the suspension tongue 116. Due to the Pemto slider is much heavier than the Femto slider, the mass and the strength can be significant enough to cause the suspension tongue to separate from the load beam by a distance when the slider is in operation or suffered the non operation shock. And in turn, it will damage the structure of the flexure, for example, cause a permanent deformation.

Accordingly, it is desired to provide an improved suspension, HGA and disk drive unit to overcome the above-mentioned drawbacks.

### SUMMARY OF THE INVENTION

One objective of the present invention is to provide a suspension adapted for a Pemto slider, thereby improving the shockproof performance of the flexure of the suspension and, in turn, protecting the structure of the suspension.

Another objective of the present invention is to provide a HGA having a suspension adapted for a Pemto slider, thereby improving the shockproof performance of the flexure of the suspension and, in turn, protecting the structure of the suspension.

Still another objective of the present invention is to provide a disk drive unit, thereby improving the shockproof performance of the flexure of the suspension and, in turn, protecting the structure of the suspension.

To achieve above objectives, a suspension for a HGA includes a flexure having a suspension tongue and a welding portion separating from the suspension tongue, and a load beam supporting the suspension tongue and having a portion welded to the welding portion of the flexure so that the load beam and the flexure are connected together. A plurality of bonding pads is formed on the suspension tongue for electrical connection to a slider. Therein the suspension tongue has a leading portion and a leading edge limiter formed at the leading portion, and the leading edge limiter hooks on to the load beam.

As an embodiment of the present invention, the load beam defines a hollow accordingly to the leading edge limiter, and the leading edge limiter bends from the leading portion and extends downward to hook in the hollow of the load beam.

Preferably, the hollow of the load beam has a wider portion and a narrower portion communicating with the wider portion, the leading edge limiter has an enlarged tail end which comes through the wider portion and hooks in the narrower portion of the hollow.

Preferably, the hollow of the load beam is T-shaped, and the leading edge limiter is also T-shaped.

Preferably, the flexure further includes a pair of straight struts extending along a longitudinal direction thereof and respectively connected to the suspension tongue.

Preferably, the flexure further includes a pair of arms embracing the suspension tongue and respectively connecting the straight struts with the welding portion.

A HGA includes a slider and a suspension for supporting the slider. The suspension includes a flexure having a suspension tongue and a welding portion separating from the suspension tongue, and a load beam supporting the suspension tongue and having a portion welded to the welding portion of the flexure so that the load beam and the flexure are connected together. A plurality of bonding pads is formed on the suspension tongue for electrical connection to a slider. Therein the suspension tongue has a leading portion and a leading edge limiter formed at the leading portion, and the leading edge limiter hooks on to the load beam.

As an embodiment of the present invention, the load beam defines a hollow accordingly to the leading edge limiter, and the leading edge limiter bends from the leading portion and extends downward to hook in the hollow of the load beam.

Preferably, the hollow of the load beam has a wider portion and a narrower portion communicating with the wider portion, the leading edge limiter has an enlarged tail end which comes through the wider portion and hooks in the narrower portion of the hollow.

Preferably, the hollow of the load beam is T-shaped, and the leading edge limiter is also T-shaped.

Preferably, the flexure further includes a pair of straight struts extending along a longitudinal direction thereof and respectively connected to the suspension tongue.

Preferably, the flexure further includes a pair of arms embracing the suspension tongue and respectively connecting the straight struts with the welding portion.

A disk drive unit includes a HGA including a slider and a suspension for supporting the slider, a drive arm connected to the HGA, a disk, and a spindle motor to spin the disk. The suspension includes a flexure having a suspension tongue and a welding portion separating from the suspension tongue, and a load beam supporting the suspension tongue and having a portion welded to the welding portion of the flexure so that the load beam and the flexure are connected together. A plurality of bonding pads is formed on the suspension tongue for electrical connection to a slider. Therein the suspension tongue has a leading portion and a leading edge limiter formed at the leading portion, and the leading edge limiter hooks on to the load beam.

In comparison with the prior art, the leading edge limiter is formed at the leading portion of the suspension tongue and hooks on to the load beam, when the Pemto slider is mounted on the suspension tongue, the leading edge limiter will prevent the suspension tongue separating from the load beam by a distance and, in turn, prevent the flexure of the suspension being damaged or caused permanent deformation. Additionally, when the shock loads are transferred to the suspension during non operation shock or operation shock within the disk drive, the leading edge limiter can limit the movement of the direction that is perpendicular to surface of the suspension tongue. Thus the shockproof performance of the flexure of the suspension is improved, and the structure of the suspension is protected.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a partial perspective view of a conventional disk drive unit;

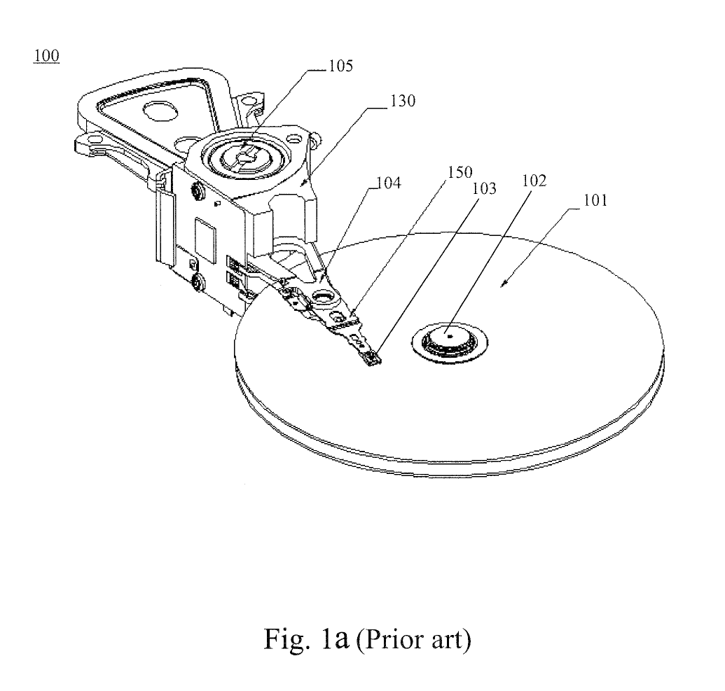

FIG. 1b is a partial top plan view of a conventional HGA;

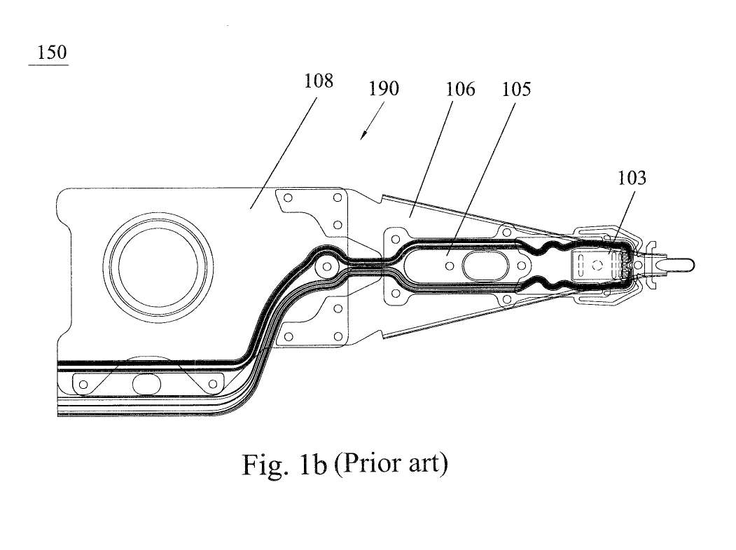

FIG. 1c is a top plan view of a suspension of the HGA shown in FIG. 1b;

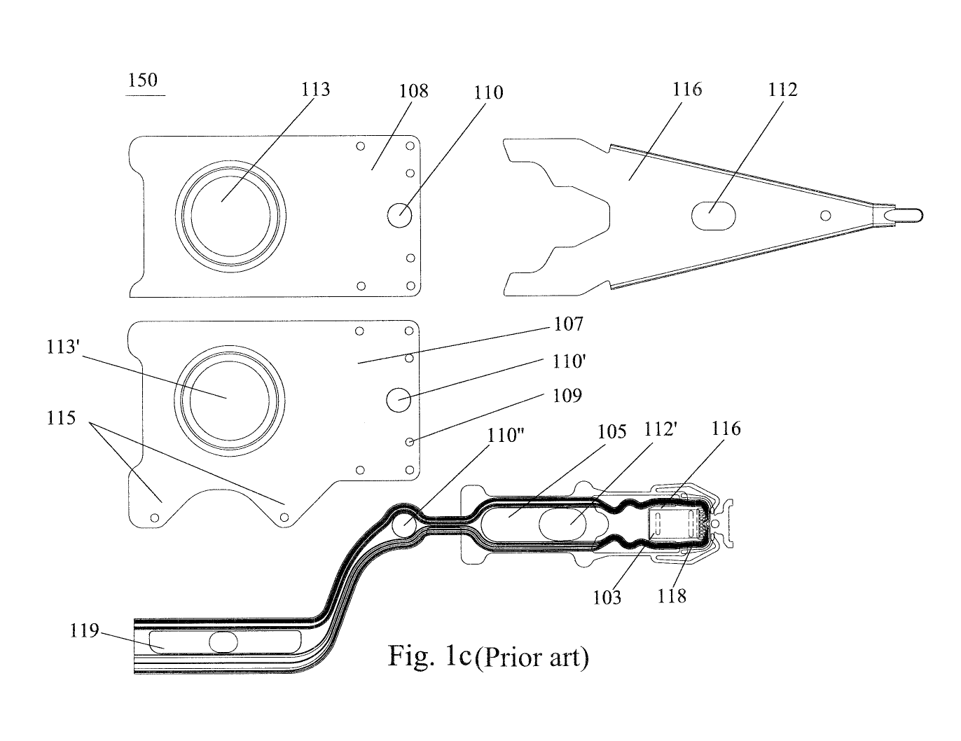

FIG. 1d is a detailed top plan view of a flexure of the suspension shown in FIG. 1c;

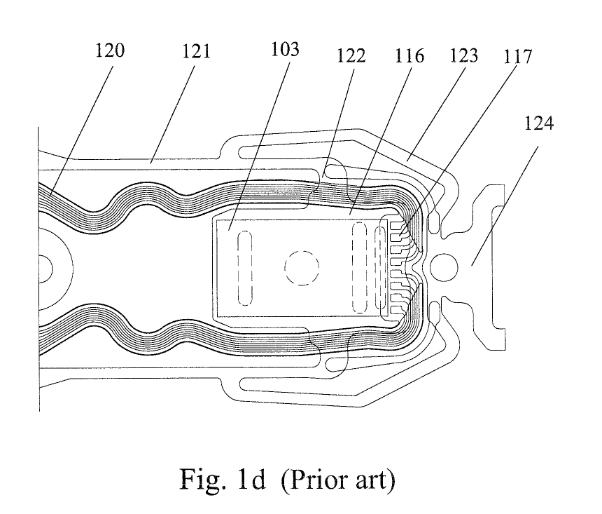

FIG. 2 is a top plan view of a suspension according to an embodiment of the present invention;

FIG. 3 is an exploded view of the suspension shown in FIG. 2;

FIG. 4a is a detailed view of the flexure of the suspension shown in FIG. 2;

FIG. 4b is a detailed partial view of the suspension shown in FIG. 2;

FIG. 5 is a top plan view of a HGA incorporating the suspension shown in FIG. 2;

FIG. 6 is a partial enlarged perspective view of the HGA shown in FIG. 5;

FIG. 7 shows a movement of Z-axis direction of the slider of the HGA shown in FIG. 6;

FIG. 8 is a perspective view of a disk drive unit according to an embodiment of the present invention.

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a suspension for a HGA of a disk drive unit, which includes a flexure with a suspension tongue for supporting a slider of the HGA and a welding portion separating from the suspension tongue, and a load beam supporting the suspension tongue and having a portion welded to the welding portion of the flexure. The suspension tongue has a leading portion and a leading edge limiter formed at the leading portion, and the leading edge limiter hooks on to the load beam. By such a design, when the Pemto slider is mounted on the suspension tongue, the leading edge limiter will prevent the suspension tongue separating from the load beam by a distance and, in turn, prevent the flexure being damaged or caused permanent deformation. Additionally, when the shock loads are transferred to the suspension during non operation shock or operation shock within the disk drive, the leading edge limiter can limit the movement of the direction that is perpendicular to surface of the suspension tongue.

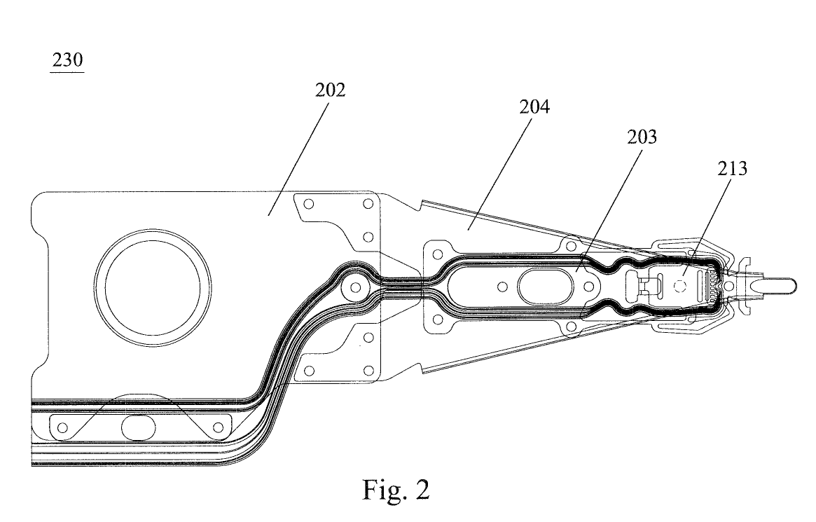

FIG. 2 shows a first embodiment of a suspension of the present invention. As illustrated in FIG. 2, a suspension 230 including a load beam 204, a base plate 201, a hinge 202, a flexure 203, all of which are assembled with each other.

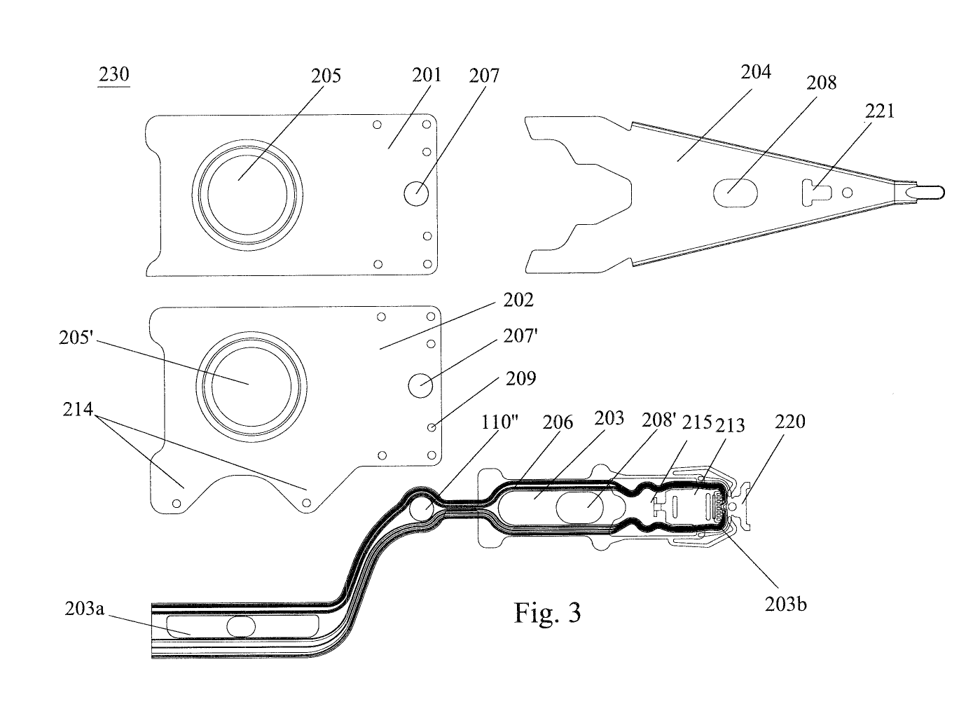

FIG. 3 is an exploded view of the suspension 230 shown in FIG. 2. Referring to FIGS. 2-3, the load beam 204 is used to transfer load forces to the flexure 203 and a slider mounted on the flexure 203. Any suitable rigid material such as stainless steel may be used to form the load beam 204 such that the load beam 204 has sufficient stiffness to transfer the load forces to the flexure 203. The load beam 204 is connected to the base plate 201 by the hinge 202. A locating hole 208 is formed on the load beam 204 for aligning itself with the flexure 203.

The base plate 201 is used to enhance structure stiffness of the whole suspension and may be made of rigid material such as stainless steel. A mounting hole 205 is formed on one end of the base plate 201 for mounting the whole suspension 230 to a motor arm of a disk drive.

The hinge 202 has a mounting hole 205′ formed on its one end corresponding to the mounting hole 205 of the base plate 201, and the hinge 202 is partially mounted to the base plate 201 with the mounting holes 207, 207′ aligned with each other. The hinge 202 and the base plate 201 may be bonded together by laser welding at a plurality of pinpoints 209 distributed on the hinge 202. In addition, two hinge steps 214 may be integrally formed at one side of the hinge 202 at one end adjacent the mounting hole 205′, for connecting with the flexure 203.

The flexure 203 is made of flexible material and runs from the hinge 202 to the load beam 204. The flexure 203 has a proximal end 203b adjacent the hinge 202 and a distal end 203a adjacent the load beam 204. A locating hole 208′ is formed in the proximal end 203b of the flexure 203 and is aligned with the locating hole 208 of the load beam 204. The perfect alignment between the locating holes 208 and 208′ can assure a high assembly precision between the flexure 203 and the load beam 204. And a mounting hole 207″ is formed on the flexure 203 and aligned with the holes 207 and 207′.

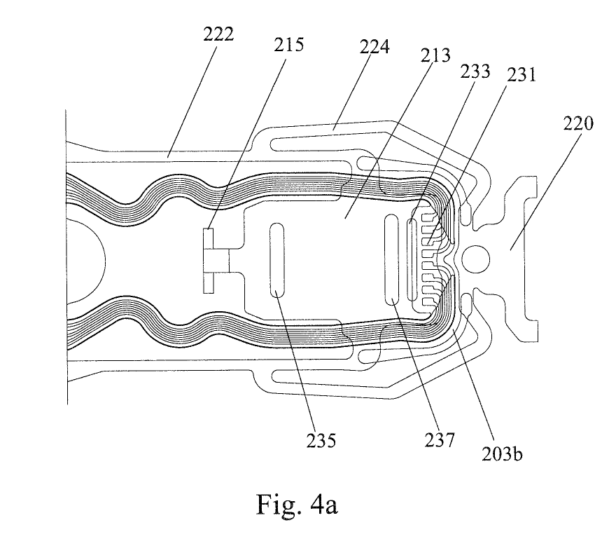

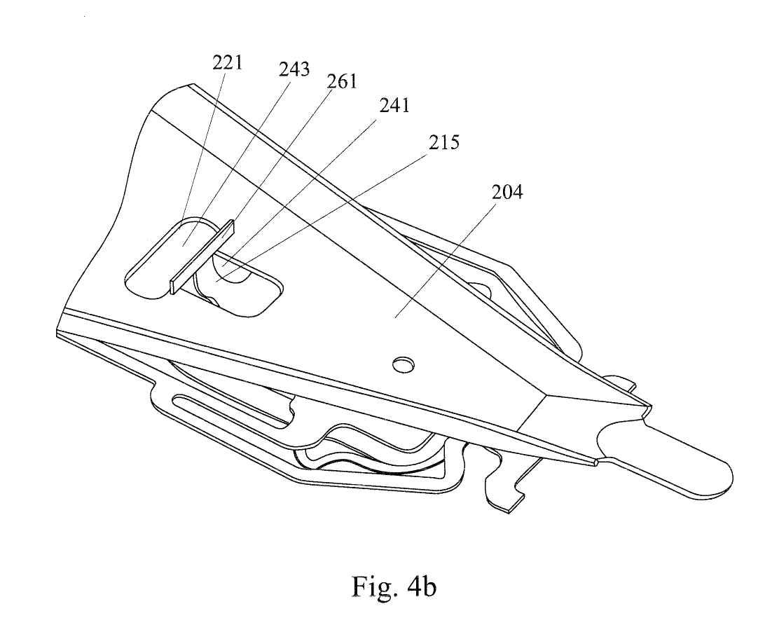

Referring to FIG. 4a, a suspension tongue 213 is provided at the proximal end 203b of the flexure 203 to support a slider thereon. A plurality of bonding pads 231 is formed on the suspension tongue 213 for electrical connection to the slider. A plurality of traces 206 runs along the flexure 203 on both sides, from the suspension tongue 213 toward the bonding pads 231 on the proximal end 203b, to connect with a flex cable of the VCM (not shown). The flexure 203 further includes a welding portion 220 separating from the suspension tongue 213, a pair of straight struts 222 respectively connected to the suspension tongue 213 and extending along a longitudinal direction of the flexure 203, and a pair of arms 224 embracing the suspension tongue 213 and connecting the straight struts 222 with the welding portion 220. The welding portion 220 of the flexure 203 is welded to the load beam 204. A slot 233 is formed on the suspension tongue 213 adjacent the trailing portion of the suspension tongue 213. The slot 233 allows a slider, and more specifically, the magnetic transducers thereof to be electrically coupled to a plurality of electrical bonding pads 231 provided on the trailing portion of the suspension tongue 213.

For absorbing thermal deformation of the suspension tongue 213 caused by ambient temperature change, two cutouts 235 and 237 are defined within the suspension tongue 213. When ambient temperature changes, for example the temperature rises or decreases drastically, expansion or contraction stress will be generated inside the suspension tongue 213, and the stress will make the suspension tongue 213 expand or contract severely; however, due to existence of the cutouts, the expansion or contraction stress will be absorbed or counterbalanced by deformation of the cutouts; resultantly, these cutouts will be deformed, but the profile of entire suspension tongue 213 will still be maintained originally. Therefore, original position and profile of the slider mounted on the suspension tongue 213 will also be maintained, and correspondingly, the flying height of the slider will be kept unchanged, thus maintaining a good flying performance for the slider.

As shown in FIGS. 4a and 4b, a leading edge limiter 215 is formed on the leading portion of the suspension tongue 213. The load beam 204 has a hollow 221 accordingly to the leading edge limiter 215, and the leading edge limiter 215 bends from the leading portion and extends downward to hook in the hollow 221 of the load beam 204. Concretely, the hollow 221 of the load beam 204 has a wider portion 241 and a narrower portion 243 communicating with the wider portion 241, the leading edge limiter 215 has an enlarged tail end 261 which comes through the wider portion 241 and hooks in the narrower portion 243 of the hollow 221, as shown in FIG. 4b. In the preferred embodiment, the hollow 221 of the load beam 204 and the leading edge limiter 215 are T-shaped. It's easy to know, the size of the T-shaped hollow 221 is bigger than the size of the leading edge limiter 215. Such a design of the leading edge limiter, it will be helpful to improve the shockproof performance of the flexure. Detailed description will be shown in the following illustrations.

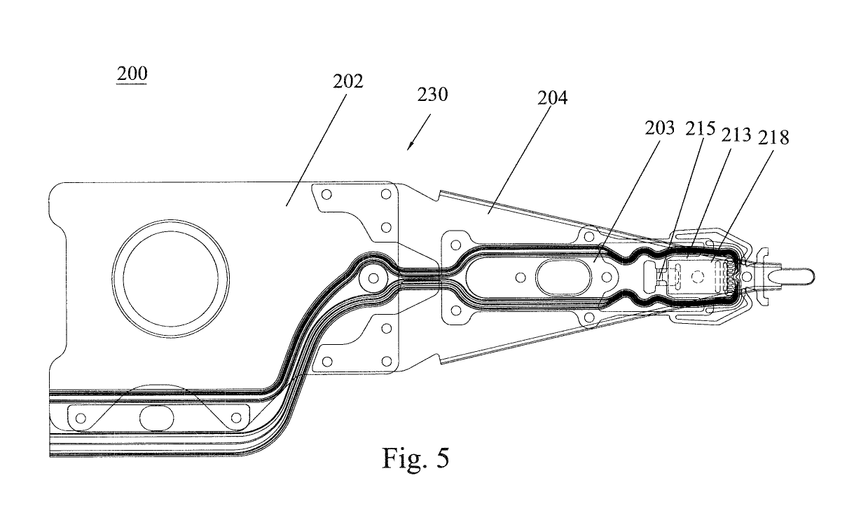

Now referring to FIG. 5, a HGA 200 according to an embodiment of the invention includes the suspension 230 and the slider 218 carried on the suspension 230. It should be noticed that, the slider of the present invention is mainly directed to the Pemto slider, but the slider which is heavier than the Pemto slider is also allowable, for example the Pico slider. For being understood well, the present description concentrates on the embodiment applying the Pemto slider. The suspension 230 includes the load beam 204, the base plate 201, the hinge 202, the flexure 203 and a leading edge limiter 215, all of which are assembled with each other. The hinge 202 has a mounting hole 202a formed thereon to assemble the hinge 202 to the base plate 201. And then the slider 218 is carried on the flexure 203. The leading edge limiter 215 is formed on the suspension tongue 213 of the flexure 203.

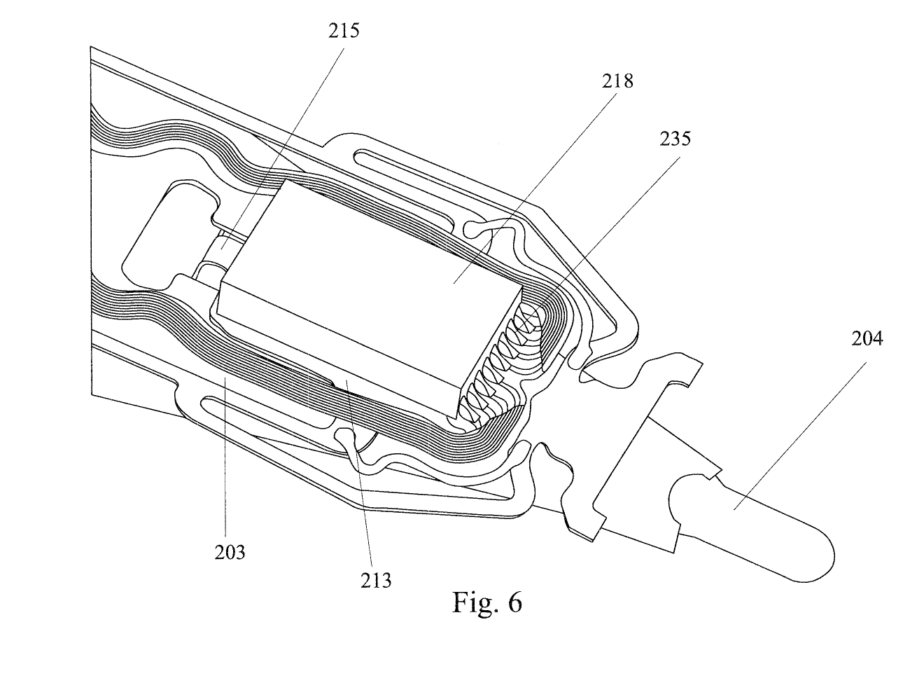

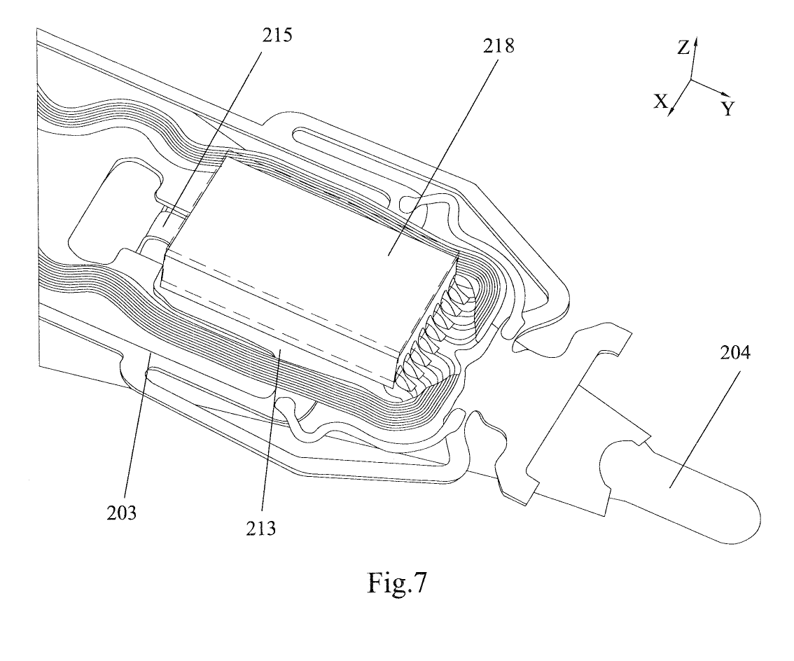

FIGS. 6-7 show a detail structure of a HGA incorporating the suspension shown in FIG. 4 and the slider 218. Referring to FIGS. 6-7, the slider 218 is mounted on the suspension tongue 213, and the slider 218 has multiple electrical pads (not shown) formed thereon. The bonding pads 231 (shown in FIG. 4a) is electrically connected with the electrical pads which are formed on the slider 218 by electrical balls 235, such as golden bonding ball and solder bonding ball.

Now please refer to FIG. 7, showing the movement state of the slider 218 and the effect to the suspension 230. Normally, the slider 218 moves in Y-axis direction. However, when a shock or vibration event come from Z-axis direction to the suspension 230, the slider 218 will move up and down, namely along the Z-axis direction. As an operation shock or a non-operation shock happens within a disk drive, the shock loads is transferred to the suspension tongue 213 and, in turn, transferred to the load beam 204. Since the leading edge limiter 215 is configured at the leading portion of the suspension tongue 213 and hooks on to the load beam 204 (referring to FIG. 4b), thus the shock or vibration transferred from the suspension tongue 213 of the flexure 203 to the load beam 204 will be limited by the leading edge limiter 215, and the movement of Z-axis direction of the flexure 203 is avoided. Therefore, the flexure structure is protected and prevented from being damaged. Thus the shockproof performance of the flexure of the suspension is improved, and the structure of the suspension is protected. It should be noticed that, the shape of the leading edge limiter is not limited to the embodiment mentioned above, the other reasonable shapes are also suitable.

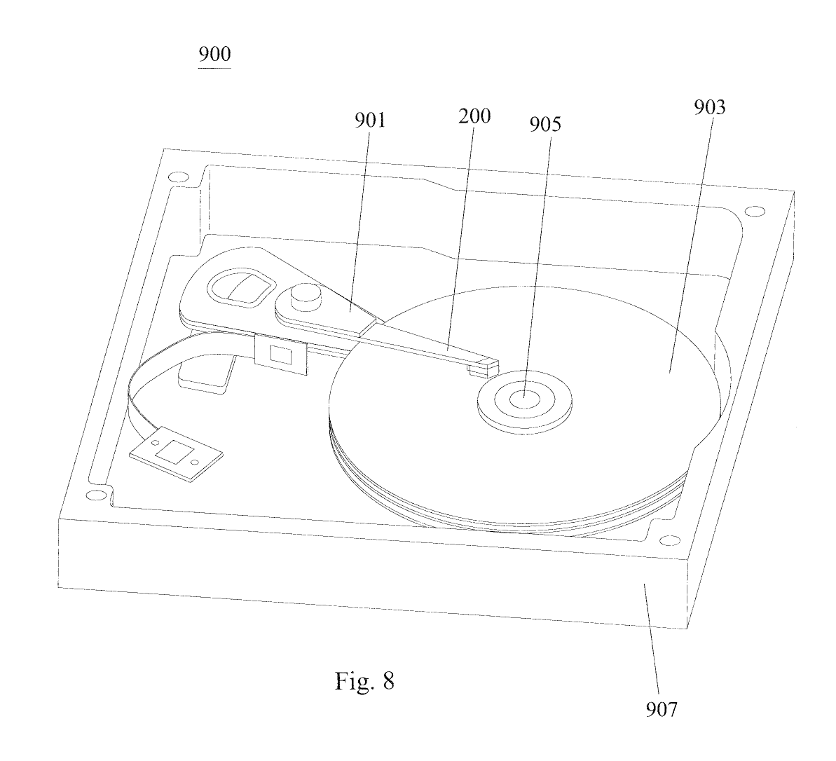

FIG. 8 is a disk drive unit 900 according to an embodiment of the present invention. The disk drive unit 900 comprises the HGA 200, a drive arm 901 connected to the HGA 200, a series of rotatable disks 903, and a spindle motor 905 to spin the disk 903, all of which are mounted in a housing 907. Because the structure and/or assembly process of disk drive unit of the present invention are well known to persons ordinarily skilled in the art, a detailed description of such structure and assembly is omitted herefrom.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A suspension for a head gimbal assembly, comprising:
a flexure having a suspension tongue and a welding portion separating from the suspension tongue, a plurality of bonding pads being formed on the suspension tongue for electrical connection to a slider; and
a load beam supporting the suspension tongue and having a portion welded to the welding portion of the flexure so that the load beam and the flexure are connected together;
wherein the suspension tongue has a leading portion and a leading edge limiter formed at the leading portion, and the leading edge limiter hooks on to the load beam.

2. The suspension as claimed in claim 1, wherein the load beam defines a hollow accordingly to the leading edge limiter, and the leading edge limiter bends from the leading portion and extends downward to hook in the hollow of the load beam.

3. The suspension as claimed in claim 2, wherein the hollow of the load beam has a wider portion and a narrower portion communicating with the wider portion, the leading edge limiter has an enlarged tail end which comes through the wider portion and hooks in the narrower portion of the hollow.

4. The suspension as claimed in claim 2, wherein the hollow of the load beam is T-shaped, and the leading edge limiter is also T-shaped.

5. The suspension as claimed in claim 1, wherein the flexure further comprises a pair of straight struts extending along a longitudinal direction thereof and respectively connected to the suspension tongue.

6. The suspension as claimed in claim 5, wherein the flexure further comprises a pair of arms embracing the suspension tongue and respectively connecting the straight struts with the welding portion.

7. A head gimbal assembly, comprising:
a slider; and
a suspension for supporting the slider, comprising:
a flexure having a suspension tongue and a welding portion separating from the suspension tongue, a plurality of bonding pads being formed on the suspension tongue for electrical connection to the slider; and
a load beam supporting the suspension tongue and having a portion welded to the welding portion of the flexure so that the load beam and the flexure are connected together;
wherein the suspension tongue has a leading portion and a leading edge limiter formed at the leading portion, and the leading edge limiter hooks on to the load beam.

8. The head gimbal assembly claimed as claim 7, wherein the load beam defines a hollow accordingly to the leading edge limiter, and the leading edge limiter bends from the leading portion and extends downward to hook in the hollow of the load beam.

9. The head gimbal assembly as claimed in claim 8, wherein the hollow of the load beam has a wider portion and a narrower portion communicating with the wider portion, the leading edge limiter has an enlarged tail end which comes through the wider portion and hooks in the narrower portion of the hollow.

10. The head gimbal assembly as claimed in claim 8, wherein the hollow of the load beam is T-shaped, and the leading edge limiter is also T-shaped.

11. The head gimbal assembly as claimed in claim 7, wherein the flexure further comprises a pair of straight struts extending along a longitudinal direction thereof and respectively connected to the suspension tongue.

12. The head gimbal assembly as claimed in claim 11, wherein the flexure further comprises a pair of arms embracing the suspension tongue and respectively connecting the straight struts with the welding portion.

13. A disk drive unit, comprising:
a head gimbal assembly including a slider and a suspension for supporting the slider;
a drive arm connected to the head gimbal assembly;
a disk; and
a spindle motor to spin the disk;
wherein the suspension comprising:
a flexure having a suspension tongue and a welding portion separating from the suspension tongue, a plurality of bonding pads being formed on the suspension tongue for electrical connection to the slider; and
a load beam supporting the suspension tongue and having a portion welded to the welding portion of the flexure so that the load beam and the flexure are connected together;
wherein the suspension tongue has a leading portion and a leading edge limiter formed at the leading portion, and the leading edge limiter hooks on to the load beam.
